(19) United States
(12) Patent Application Publication
(10) Pub. No.: US 2012/0104997 A1
(43) Pub. Date: May 3, 2012

(54) WIRELESS CHARGING DEVICE

(75) Inventor: Francesco Carobolante, San Diego, CA (US)

(73) Assignee: QUALCOMM INCORPORATED, San Diego, CA (US)

(21) Appl. No.: 13/047,691

(22) Filed: Mar. 14, 2011

Related U.S. Application Data
(60) Provisional application No. 61/409,047, filed on Nov. 1, 2010.

(51) Int. Cl. H02J 7/00

(52) U.S. Cl. 320/108

(57) ABSTRACT

Exemplary embodiments are directed to wirelessly charging a chargeable device. A device may include a receiver configured to receive a stored power status from an embeddable, chargeable device. The device may further include a transmitter configured to wirelessly transmit power to charge the embeddable, chargeable device based on the stored power status.

### CLAIM OF PRIORITY UNDER 35 U.S.C. §119

This application claims priority under 35 U.S.C. §119(e) to: U.S. Provisional Patent Application 61/409,047 entitled “WIRELESS CHARGING OF SENSORS” filed on Nov. 1, 2010, the disclosure of which is hereby incorporated by reference in its entirety.

### BACKGROUND

1. Field

The present invention relates generally to wireless power, and more specifically, to systems, device, and methods for providing a power status of and wirelessly charging a device.

2. Background

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2 m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms to tens of mms), hence the user must locate the devices in a specific area.

As will be understood by a person having ordinary skill in the art, electronic devices may require periodic charging or substitution of an internal battery. Furthermore, a user of the electronic device may not be aware that the internal battery is in need of charge. A need exists for devices, systems, and methods related to a device, which can provide the functionality of providing a power status of a battery of device to a user, alerting the user when the battery needs to be charged, as well as including the means to perform the charging.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 is a simplified block diagram of a receiver, in accordance with an exemplary embodiment of the present invention.

FIG. 6A and FIG. 6B illustrate various operational contexts for an electronic device configured for bidirectional wireless power transmission, in accordance with exemplary embodiments.

FIG. 7 illustrates a system including a first electronic device for wirelessly transmitting power to a second electronic device, according to an exemplary embodiment of the present invention.

FIG. 8 illustrates an electronic device having a display for displaying a charging status of another electronic device, in accordance with an exemplary embodiment of the present invention.

FIG. 9 is a flowchart illustrating a method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The term “wireless power” is used herein to mean any form of energy associated with electric fields, magnetic fields, electromagnetic fields, or otherwise that is transmitted from a transmitter to a receiver without the use of physical electrical conductors. Hereafter, all three of this will be referred to generically as radiated fields, with the understanding that pure magnetic or pure electric fields do not radiate power. These must be coupled to a “receiving antenna” to achieve power transfer.

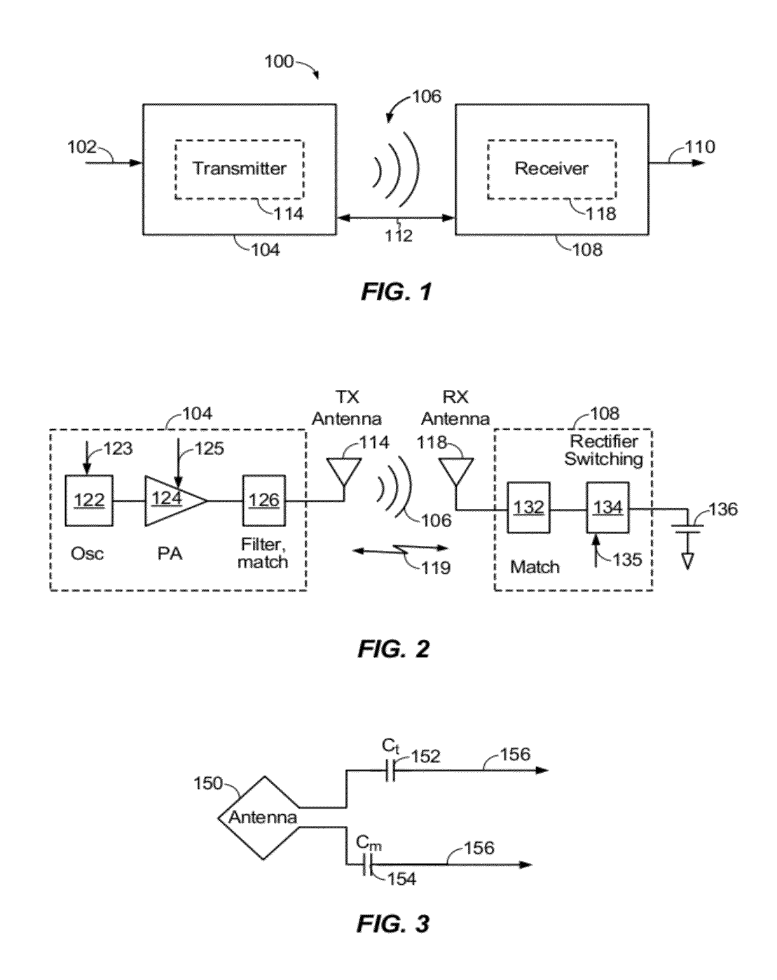

FIG. 1 illustrates a wireless transmission or charging system 100, in accordance with various exemplary embodiments of the present invention. Input power 102 is provided to a transmitter 104 for generating a field 106 for providing energy transfer. A receiver 108 couples to the field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region. It is noted that according to various exemplary embodiments of the present invention, a single device (e.g. a mobile telephone) may include receiver (e.g., receiver 108) configured to wirelessly receive power from another wireless transmitter, and a transmitter (e.g., transmitter 104) for wirelessly transmitting power to a device. As described more fully below, a mobile device, such as a mobile telephone may comprise transmitter 104. Further, an embeddable device, such as a medical sensor, may comprise receiver 108.

FIG. 2 shows a simplified schematic diagram of a wireless power transfer system. The transmitter 104 includes an oscillator 122, a power amplifier 124 and a filter and matching circuit 126. The oscillator is configured to generate at a desired frequency, such as 468.75 KHz, 6.78 MHz or 13.56 MHz, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate by modulating the field or on a separate communication channel 119 (e.g., Bluetooth, zigbee, cellular, etc).

According to one exemplary embodiment, transmitter 104 may be integrated within a mobile device, such as a mobile telephone, and receiver 108 may be integrated within a chargeable device, such as a device that is embeddable within a living organism. In this exemplary embodiment, receiver 108 may be able to transmit a communication signal to transmitter 108 indicative of a charging status thereof. Further, transmitter 104 may wirelessly transmit power to receiver 104, which is positioned within a charging region of transmitter 104.

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, in one particular example, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

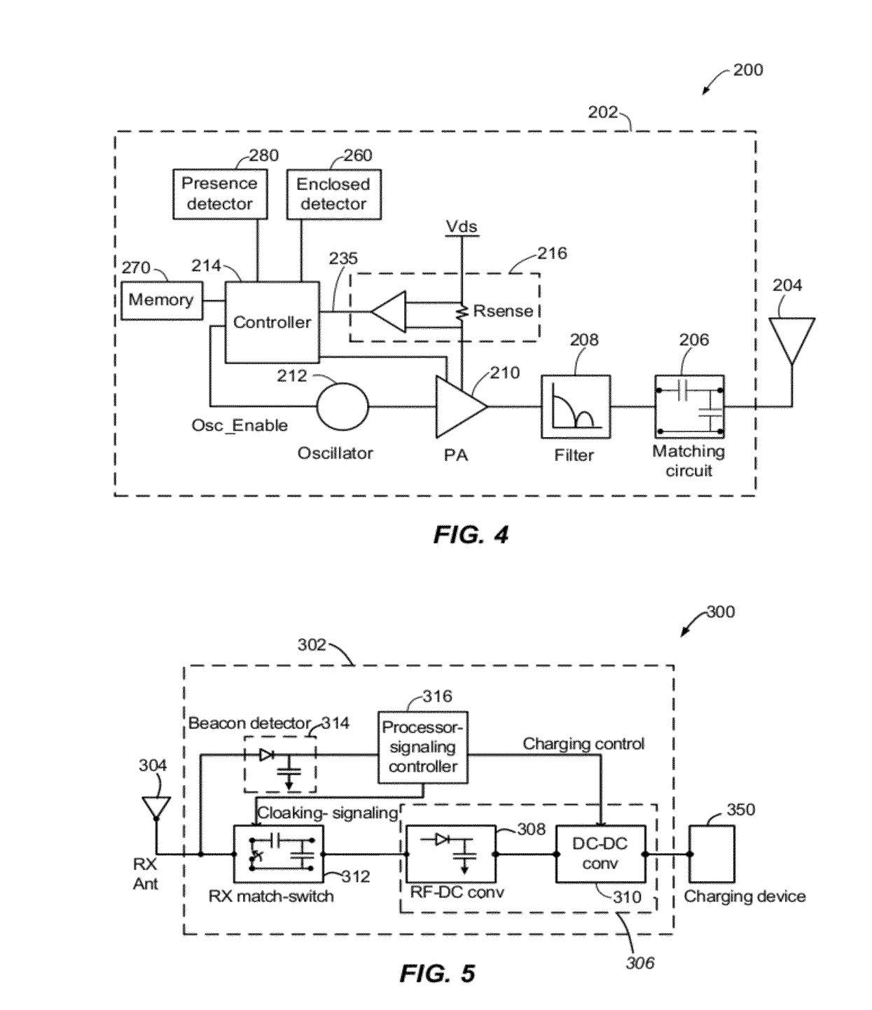

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. It is noted that transmitter 200 may operate at any suitable frequency. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current drawn by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be less than 1 W or on the order of a few Watts, depending on the application.

Transmit circuitry 202 may further include a controller 214 for enabling the oscillator 212 during transmit phases (or duty cycles) for specific receivers, for adjusting the frequency or phase of the oscillator, and for adjusting the output power level for matching the power requirement of the receiver or for implementing a communication protocol for interacting with neighboring devices through their attached receivers. As is well known in the art, adjustment of oscillator phase and related circuitry in the transmission path allows for reduction of out of band emissions, especially when transitioning from one frequency to another.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy and to communicate with an active receiver.

Transmit antenna 204 may be implemented with a Litz wire or as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

As a non-limiting example, the presence detector 280 may be a motion detector utilized to sense the initial presence of a device to be charged that is inserted into the coverage area of the transmitter. After detection, the transmitter may be turned on and the RF power received by the device may be used to toggle a switch on the Rx device in a pre-determined manner, which in turn results in changes to the driving point impedance of the transmitter.

As another non-limiting example, the presence detector 280 may be a detector capable of detecting a human, for example, by infrared detection, motion detection, or other suitable means. In some exemplary embodiments, there may be regulations limiting the amount of power that a transmit antenna may transmit at a specific frequency. In some cases, these regulations are meant to protect humans from electromagnetic radiation. However, there may be environments where transmit antennas are placed in areas not occupied by humans, or occupied infrequently by humans, such as, for example, garages, factory floors, shops, and the like. If these environments are free from humans, it may be permissible to increase the power output of the transmit antennas above the normal power restrictions regulations. In other words, the controller 214 may adjust the power output of the transmit antenna 204 to a regulatory level or lower in response to human presence and adjust the power output of the transmit antenna 204 to a level above the regulatory level when a human is outside a regulatory distance from the electromagnetic field of the transmit antenna 204.

As a non-limiting example, the enclosed detector 290 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 200 does not remain on indefinitely may be used. In this case, the transmitter 200 may be programmed to shut off after a user-determined amount of time. This feature prevents the transmitter 200, notably the power amplifier 210, from running long after the wireless devices in its perimeter are fully charged. This event may be due to the failure of the circuit to detect the signal sent from either the repeater or the receive coil that a device is fully charged. To prevent the transmitter 200 from automatically shutting down if another device is placed in its perimeter, the transmitter 200 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a simplified block diagram of a receiver 300, in accordance with an exemplary embodiment of the present invention. The receiver 300 includes receive circuitry 302 and a receive antenna 304. Receiver 300 further couples to device 350 for providing received power thereto. It should be noted that receiver 300 is illustrated as being external to device 350 but may be integrated into device 350. Generally, energy is propagated wirelessly to receive antenna 304 and then coupled through receive circuitry 302 to device 350.

Receive antenna 304 is tuned to resonate at the same frequency, or within a specified range of frequencies, as transmit antenna 204 (FIG. 4). Receive antenna 304 may be similarly dimensioned with transmit antenna 204 or may be differently sized based upon the dimensions of the associated device 350. By way of example, device 350 may be a portable electronic device having diametric or length dimension smaller that the diameter of length of transmit antenna 204. In such an example, receive antenna 304 may be implemented as a multi-turn antenna in order to reduce the capacitance value of a tuning capacitor (not shown) and increase the receive antenna's impedance. By way of example, receive antenna 304 may be placed around the substantial circumference of device 350 in order to maximize the antenna diameter and reduce the number of loop turns (i.e., windings) of the receive antenna and the inter-winding capacitance.

Receive circuitry 302 provides an impedance match to the receive antenna 304. Receive circuitry 302 includes power conversion circuitry 306 for converting a received RF energy source into charging power for use by device 350. Power conversion circuitry 306 includes an RF-to-DC converter 308 and may also include a DC-to-DC converter 310. RF-to-DC converter 308 rectifies the RF energy signal received at receive antenna 304 into a non-alternating power while DC-to-DC converter 310 converts the rectified RF energy signal into an energy potential (e.g., voltage) that is compatible with device 350. Various RF-to-DC converters are contemplated, including partial and full rectifiers, regulators, bridges, doublers, as well as linear and switching converters.

Receive circuitry 302 may further include switching circuitry 312 for connecting receive antenna 304 to the power conversion circuitry 306 or alternatively for disconnecting the power conversion circuitry 306. Disconnecting receive antenna 304 from power conversion circuitry 306 not only suspends charging of device 350, but also changes the “load” as “seen” by the transmitter 200 (FIG. 2).

As disclosed above, transmitter 200 includes load sensing circuit 216 which detects fluctuations in the bias current provided to transmitter power amplifier 210. Accordingly, transmitter 200 has a mechanism for determining when receivers are present in the transmitter's near-field.

When multiple receivers 300 are present in a transmitter's near-field, it may be desirable to time-multiplex the loading and unloading of one or more receivers to enable other receivers to more efficiently couple to the transmitter. A receiver may also be cloaked in order to eliminate coupling to other nearby receivers or to reduce loading on nearby transmitters. This “unloading” of a receiver is also known herein as a “cloaking ” Furthermore, this switching between unloading and loading controlled by receiver 300 and detected by transmitter 200 provides a communication mechanism from receiver 300 to transmitter 200 as is explained more fully below. Additionally, a protocol can be associated with the switching which enables the sending of a message from receiver 300 to transmitter 200. By way of example, a switching speed may be on the order of 100 μsec.

In an exemplary embodiment, communication between the transmitter and the receiver refers to a device sensing and charging control mechanism, rather than conventional two-way communication. In other words, the transmitter may use on/off keying of the transmitted signal to adjust whether energy is available in the near-field. The receivers interpret these changes in energy as a message from the transmitter. From the receiver side, the receiver may use tuning and de-tuning of the receive antenna to adjust how much power is being accepted from the near-field. The transmitter can detect this difference in power used from the near-field and interpret these changes as a message from the receiver. It is noted that other forms of modulation of the transmit power and the load behavior may be utilized and that one-way or two-way communication protocols may be employed.

Receive circuitry 302 may further include signaling detector and beacon circuitry 314 used to identify received energy fluctuations, which may correspond to informational signaling from the transmitter to the receiver. Furthermore, signaling and beacon circuitry 314 may also be used to detect the transmission of a reduced RF signal energy (i.e., a beacon signal) and to rectify the reduced RF signal energy into a nominal power for awakening either un-powered or power-depleted circuits within receive circuitry 302 in order to configure receive circuitry 302 for wireless charging.

Receive circuitry 302 further includes processor 316 for coordinating the processes of receiver 300 described herein including the control of switching circuitry 312 described herein. Cloaking of receiver 300 may also occur upon the occurrence of other events including detection of an external wired charging source (e.g., wall/USB power) providing charging power to device 350. Processor 316, in addition to controlling the cloaking of the receiver, may also monitor beacon circuitry 314 to determine a beacon state and extract messages sent from the transmitter. Processor 316 may also adjust DC-to-DC converter 310 for improved performance.

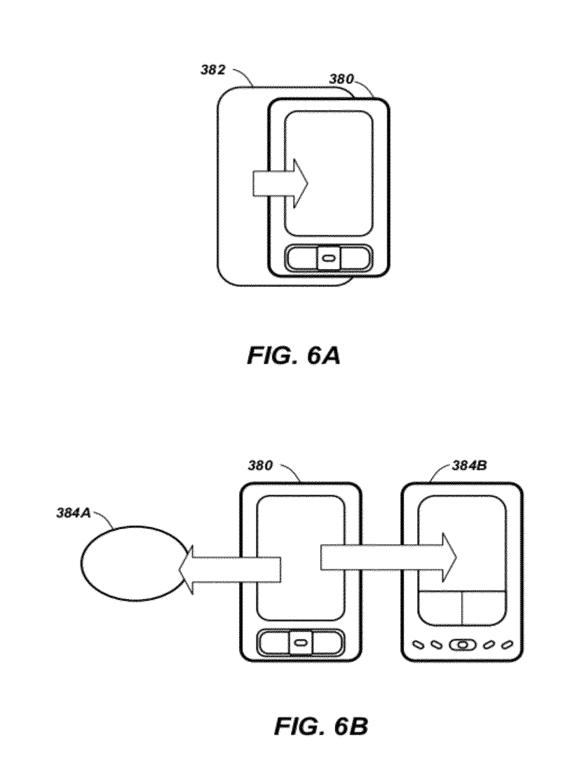

FIG. 6A and FIG. 6B illustrate various operational contexts for an electronic device configured for bidirectional wireless power transmission, in accordance with exemplary embodiments. Specifically, an electronic device 380 configured for bidirectional wireless power transmission engages in wireless power transmission with a power base 382 wherein electronic device 380 receives wireless power and stores the received power in a battery. Subsequently electronic device 380 is solicited, volunteers or otherwise is enlisted as a donor of stored power. Accordingly, one or more electronic devices 384A, 384B receive power from electronic device 380 through a wireless power transmission process.

It is contemplated that the wireless transmission process with electronic device 380 operating in a charging mode, may be to provide power replenishment e.g. in an urgency, or at least temporary charge, to another device 384B, or the charging of a micro-power device 384A, such as a medical device, wireless sensors or actuators, headsets, MP3 players, etc. For this purpose, device 380 is set into a mode via a user interface or responsive to allowed solicitations. Furthermore, electronic device 380 may also perform energy management of its own available power to avoid excessive depletion of stored power within the battery of electronic device 380. Accordingly, assuming a standardized wireless power interface, devices may be recharged or partially recharged almost everywhere from any wireless power device that can act as donor electronic device and that provides sufficient battery capacity.

Conventionally, medical devices, which are embedded within a living organism (e.g., a human being) may require a periodic substitution of an internal battery, thus requiring a surgical operation on a patient at appropriate time intervals. Exemplary embodiments of the invention relate to a device, which is normally carried by a user, such as a mobile telephone, which can provide the functionality of providing a charging status of a battery of an device (e.g., a sensor) embedded within or affixed to a user or structure, alerting the user when the battery of the embedded device needs to be recharged, as well as including the means to perform the recharging. It is noted that since a battery of a mobile device (e.g., a mobile telephone) is usually an order of magnitude, or more, larger than that utilized by an embedded device, the drain on the mobile device battery is negligible, therefore, such recharge can be done without significantly affecting the mobile device usage.

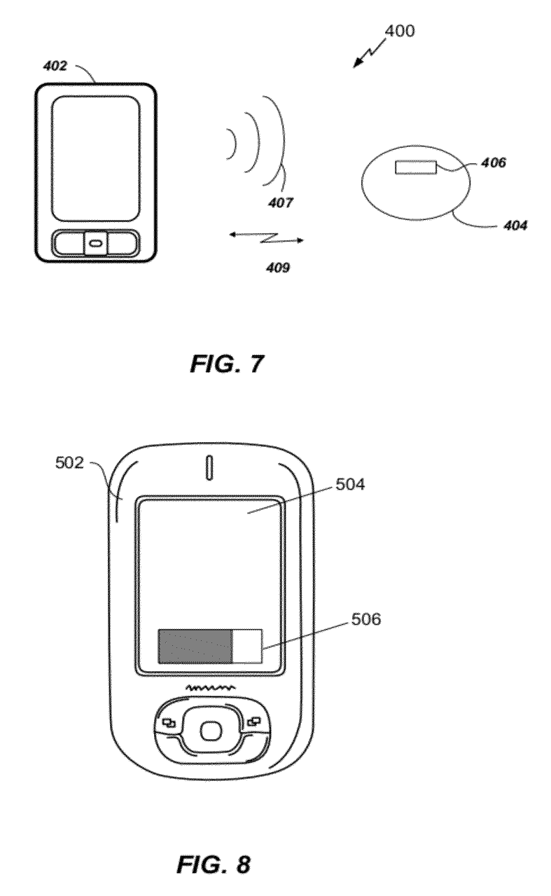

FIG. 7 illustrates a system 400 including an electronic device 402 and a chargeable device 404. Electronic device 402 may include one or more receivers (e.g., receiver 300 of FIG. 5) for wirelessly receiving power and wirelessly receiving data, and one or more transmitter (transmitter 200 of FIG. 4) for wirelessly transmitting power (e.g., field 407) and, possibly, wirelessly transmitting data. It is noted that, within the electronic device 402, transmit antenna 204 and receive antenna 304 may be physically the same device. Electronic device 402 may comprise any suitable electronic device, such as, for example only, a mobile telephone, a personal digital assistant (PDA), a tablet, or a combination thereof. Electronic device 402 may further include an energy storage device, such as a battery (e.g., battery 136 of FIG. 2).

System 400 further includes chargeable device 404 including an energy storage device 406, which may comprise a battery. Chargeable device 404 may include any known and suitable chargeable device. According to one example, chargeable device 404 may include a Bluetooth device. According to another example, chargeable device 404 may comprise an embeddable device, such as a medical device, a sensor, or a combination thereof. By way of example only, chargeable device 404 may comprise a sensor configured for being embedded (e.g., implanted, ingested, affixed) within or on, for example only, a living organism (e.g., a human being) or other structure. Chargeable device 404 may include one or more receivers (e.g., receiver 300 of FIG. 5) for wirelessly receiving power and, possibly, wirelessly receiving data. Chargeable device 404 may further include one or more transmitters for communicating with another electronic device, such as electronic device 402. Chargeable device 404 may be configured to transmit information associated therewith (e.g., identity information or information indicative of an associated stored power status). According to one exemplary embodiment, chargeable device 404 may be configured to emit a beacon signal indicative of a stored power status thereof. It is noted that electronic device 402 and chargeable device 404 may communicate on a separate communication channel 409 (e.g., Bluetooth, zigbee, cellular, etc).

FIG. 8 illustrates an electronic device 502, which may comprise electronic device 402 illustrated in FIG. 7. As illustrated in FIG. 8, electronic device 502 includes a display 504. As noted above, in accordance with an exemplary embodiment of the present invention, electronic device 502 may be configured to receive a signal from a remote device requesting a charge therefrom. Furthermore, electronic device 502 may be configured to receive a signal from a remote device (e.g., chargeable device 404) indicative of a charging status thereof. More specifically, electronic device 502 may receive a message from the remote device requesting a charge, a message indicative of a stored power status of a battery of the remote device, or both. As illustrated in FIG. 8, device 502 may be configured to visually display a power status 506 associated with the remote device (e.g., chargeable device 404). It is noted that other means to convey a charging status to a user are within the scope of the present invention (e.g., audibly or a text or email message).

With reference to FIGS. 7 and 8, a contemplated operation of system 400 will now be described. According to one exemplary embodiment, electronic device 402 may receive a signal from chargeable device 404, wherein the signal may comprise information related to a power status of chargeable device, a request from chargeable device 404 to wirelessly receive power, or both. Furthermore, in response to receipt of the signal, electronic device 402 may wirelessly transfer power to chargeable device 404 to charge chargeable device 404, convey information concerning a power status of chargeable device 404, convey an alert that chargeable device 404 is in need of a charge, or any combination thereof. It is noted that electronic device 402 may convey information (e.g., a power status or an alert) by any suitable means, such as an audible or lighting signal, a message on display 504 (e.g., power status 506), an email or other notification means. Furthermore, in response to receiving an alert or other information concerning a power status of chargeable device 404, a device user may proceed, when convenient, to enable electronic device 402 to transfer power to chargeable device 404.

It is noted that to enable electronic device 402 to transfer power to chargeable device 404, electronic device 402 may be transitioned into a charging mode, which may cause electronic device 402 to disable one or more other antennas that could potentially interfere with chargeable device 404. Upon being transitioned to a charging mode, a transmit antenna (e.g., transmit antenna 202 of FIG. 4) of electronic device 402 may be powered-up, and a device user may position electronic device 402 appropriately close to chargeable device (e.g., a patient/user places a mobile device in the vicinity of a device embedded in the user's body), so that it can be wirelessly charged.

At anytime during a charging process (e.g., upon a battery of chargeable device 404 being fully charged), chargeable device 404 may communicate a power status thereof to electronic device 402 via communication means (e.g. the same communication means previously utilized to alert about the state of charge, or other means, such as load modulation, etc.). In response thereto, electronic device 402 may notify a device user of the charging status. A device user may then position electronic device 402 away from chargeable device 402 and terminate the charging mode, thus resuming normal operation. This action of terminating the charge mode and resuming normal operation may be automated by electronic device 402 when signaled by chargeable device 404 or by detecting that chargeable device 404 is no longer positioned within an associated charging region of electronic device 402.

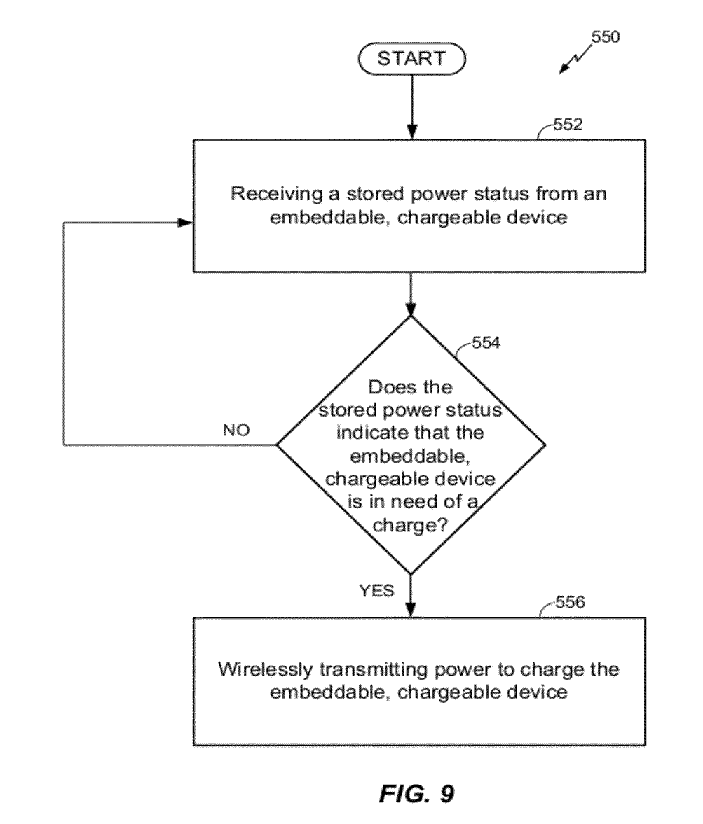

FIG. 9 is a flowchart illustrating a method 550, in accordance with one or more exemplary embodiments. Method 550 may include receiving a stored power status from an embeddable, chargeable device (depicted by numeral 552). Method 550 may include a query wherein a determination is made as to whether the stored power status indicates that the embeddable, chargeable device is in need of charge (depicted by numeral 554). Method 550 may further include wirelessly transmitting power to charge the embeddable, chargeable device if the chargeable device is in need of charge (depicted by numeral 556). If the embeddable, chargeable device does not need of charge, method 550 may revert to step 552.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
a receiver configured to receive a stored power status from an embeddable, chargeable device; and
a transmitter configured to wirelessly transmit power to charge the embeddable, chargeable device based on the stored power status.

2. The device of claim 1, further including an interface for displaying information associated with the stored power status of the chargeable device.

3. The device of claim 2, the interface configured to at least one of audibly display the stored power status of the chargeable device and visually display the stored power status of the chargeable device.

4. The device of claim 1, the chargeable device comprising a sensor embeddable within a living organism.

5. The device of claim 1, the communication signal comprising a request from the chargeable device to receive power.

6. The device of claim 1, further comprising at least one antenna comprising for wirelessly transmitting power and receiving a communication signal.

7. The device of claim 1, further configured to wirelessly receive power from a wireless power transmitter.

8. The device of claim 1, further configured to transition into a charging mode prior to wireless transmitting power to charge the embeddable, chargeable device.

9. The device of claim 8, further configured to transition from the charging mode after wireless transmitting power.

10. The device of claim 1, the device configured to receive the stored power status from the chargeable device embedded within a human body.

11. The device of claim 1, further configured to request a charging status update from the chargeable device.

12. A method, comprising:
receiving a stored power status from an embeddable, chargeable device; and
wirelessly transmitting power to charge the embeddable, chargeable device.

13. The method of claim 12, the receiving comprising receiving the signal indicative of a request for a wireless power charge.

14. The method of claim 12, the receiving comprising receiving a beacon signal indicative of the power status of the chargeable device.

15. The method of claim 12, further comprising conveying information indicative of the stored power status.

16. The method of claim 15, the conveying comprising at least one of visually conveying information indicative of the stored power status and audibly conveying information indicative of the stored power status.

17. The method of claim 12, further comprising transitioning to a charging mode prior to wirelessly transmitting power to charge the embeddable, chargeable device.

18. The method of claim 12, the receiving comprising receiving the stored power status from the chargeable device embedded within a human body.

19. The method of claim 12, further comprising wirelessly receiving power at the electronic device.

20. The method of claim 12, further comprising requesting a stored power status update from the chargeable device.

21. A device, comprising:
means for receiving a stored power status from an embeddable, chargeable device; and
means for wirelessly transmitting power to charge the embeddable, chargeable device.

22. The device of claim 21, further comprising means for transitioning to a charging mode prior to wirelessly transmitting power to the chargeable device.

23. The device of claim 21, further comprising means for conveying information associated with the stored power status of the chargeable device.
